(19) United States
(12) Patent Application Publication
(10) Pub. No.: US 2020/0017699 A1
(43) Pub. Date: Jan. 16, 2020

(54) Low Residual Carbon Binder for Binder Jetting Three-Dimensional Printing and Methods for Use of Same

(71) Applicant: The ExOne Company, North Huntingdon, PA (US)

(72) Inventor: Daniel T. Brunermer, Leechburg, PA (US)

(21) Appl. No.: 16/469,365

(22) PCT Filed: Dec. 12, 2017
(86) PCT No.: PCT/US17/65834

§ 371 Date: Jun. 13, 2019

Related U.S. Application Data
(60) Provisional application No. 62/435,485, filed on Dec. 16, 2016.

(51) Int. Cl. C09D 11/106; B29C 64/165; B33Y 10/00; B33Y 70/00

(52) U.S. Cl. CPC C09D 11/106; B29C 64/165; B29K 2029/04; B33Y 70/00; B33Y 10/00

(57) ABSTRACT

The present invention overcomes the problem with carbon increase described above by providing a binder for binder jetting three-dimensional printing that results in a much lower carbon increase after post-processing. The present invention also includes making articles by binder jetting three-dimensional printing using such inventive binders.

### BACKGROUND

### Field of the Invention

The present invention relates to binders that are adapted to be used in binder jetting three-dimensional printing and to methods of using such binders in binder jetting three-dimensional printing.

### Background

Binder jetting three-dimensional printing was developed in the 1990's at the Massachusetts Institute of Technology and is described in several United States patents, including the following U.S. Pat. Nos.: 5,490,882 to Sachs et al., U.S. Pat. No. 5,490,962 to Cima et al., U.S. Pat. No. 5,518,680 to Cima et al., U.S. Pat. No. 5,660,621 to Bredt et al., U.S. Pat. No. 5,775,402 to Sachs et al., U.S. Pat. No. 5,807,437 to Sachs et al., U.S. Pat. No. 5,814,161 to Sachs et al., U.S. Pat. No. 5,851,465 to Bredt, U.S. Pat. No. 5,869,170 to Cima et al., U.S. Pat. No. 5,940,674 to Sachs et al., U.S. Pat. No. 6,036,777 to Sachs et al., U.S. Pat. No. 6,070,973 to Sachs et al., U.S. Pat. No. 6,109,332 to Sachs et al., U.S. Pat. No. 6,112,804 to Sachs et al., U.S. Pat. No. 6,139,574 to Vacanti et al., U.S. Pat. No. 6,146,567 to Sachs et al., U.S. Pat. No. 6,176,874 to Vacanti et al., U.S. Pat. No. 6,197,575 to Griffith et al., U.S. Pat. No. 6,280,771 to Monkhouse et al., U.S. Pat. No. 6,354,361 to Sachs et al., U.S. Pat. No. 6,397,722 to Sachs et al., U.S. Pat. No. 6,454,811 to Sherwood et al., U.S. Pat. No. 6,471,992 to Yoo et al., U.S. Pat. No. 6,508,980 to Sachs et al., U.S. Pat. No. 6,514,518 to Monkhouse et al., U.S. Pat. No. 6,530,958 to Cima et al., U.S. Pat. No. 6,596,224 to Sachs et al., U.S. Pat. No. 6,629,559 to Sachs et al., U.S. Pat. No. 6,945,638 to Teung et al., U.S. Pat. No. 7,077,334 to Sachs et al., U.S. Pat. No. 7,250,134 to Sachs et al., U.S. Pat. No. 7,276,252 to Payumo et al., U.S. Pat. No. 7,300,668 to Pryce et al., U.S. Pat. No. 7,815,826 to Serdy et al., U.S. Pat. No. 7,820,201 to Pryce et al., U.S. Pat. No. 7,875,290 to Payumo et al., U.S. Pat. No. 7,931,914 to Pryce et al., U.S. Pat. No. 8,088,415 to Wang et al., U.S. Pat. No. 8,211,226 to Bredt et al., and U.S. Pat. No. 8,465,777 to Wang et al. In essence, binder jetting three-dimensional printing involves the spreading of a layer of particulate material and then selectively jet-printing a fluid onto that layer to cause selected portions of the particulate layer to bind together to form one or more articles or their negatives. This sequence is repeated for additional layers until the desired article or articles or their negatives have been constructed.

For simplicity sake, the rest of the discussion in this specification will be confined to the formation of a single article during the operation of a binder jetting three-dimensional printing process although it is to be understood that multiple different articles and/or multiple copies of the same article can be formed at the same time during a binder jetting three-dimensional printing process and such are inherently embraced by the discussion. Also for simplicity sake, the discussion will also be confined to the description of binder jetting three-dimensional printing in which the article itself, rather than its negative, is printed, although it is to be understood that the discussion inherently embraces binder jetting three-dimensional printing wherein the negative of the article is printed. It is to be noted that the term “binder jetting” is sometimes referred to in the art as “inkjet printing”.

The material making up the particulate layer is referred to herein as the “build material.” The term “binder” is used herein to refer to the jetted fluid that is applied to the build material in binder jetting three-dimensional printing. The device that applies the binder to the build material is referred to herein as a “printing mechanism.” The term “printing” and its various inflexions are used herein to refer to the jetting application of a binder by the printing mechanism upon the build material. The build material is applied one layer at a time and the accumulation of the layers at any point in time is referred to herein as the “build bed.” The top surface of the layer which is topmost in the build bed at any particular point in time is referred to herein as the “build surface.” The term “powder” is sometimes used herein to refer to the particulate material comprising the build material. The binder jetting three-dimensional printing process results in an intermediate form of the intended article and that intermediate form is referred to herein as the “as-printed article.”

The term “post-processing” is used herein to refer to steps or operations which are performed on the as-printed article. Post-processing of as-printed article is often required in order to strengthen and/or densify an as-printed article. The types of post-processing that are performed for a particular as-printed article depend on the binder and build material that were used during the binder jetting three-dimensional printing process and the desired properties the article is to have. Two post-processing operations that are often performed on as-printed articles both involve heating of the as-printed article and are often used in tandem, separated by an intermediate step. The first-in-time of these operations is referred to herein as a “curing” operation. A typical curing operation comprises heating the as-printed article while it is still contained within the build bed to drive off a portion of the binder and to increase the strength of the as-printed article (which, after curing is referred to herein as the “cured article”). The second-in-time post-processing operation is referred to herein as a “densification” process. A typical densification process comprises heating the cured article to cause its density to increase, at least in part, by the sintering together of its constituent powder particles. The term “densified article” is used herein to refer the form of the article at the completion of the densification process. Densification processes are usually performed on as-cured articles that have been removed from the powder bed during an intermediate step referred to herein as “depowdering”.

A problem existing in the prior art is that one or more of the post-processing steps result in an increase in the carbon content of the article over that of the build material due to the decomposition of one or more components of the binder during those operations. For ease of description, this increase will be referred to herein as the “carbon pickup” and the carbon contributed by the binder to the pickup will be referred to herein as the binder's “residual carbon.”

Fortunately, many build materials can tolerate the amount of such carbon pickup or the initial carbon contents of the build materials can be tailored to accommodate the carbon pickup so that the carbon content of the final article is within the required range specified for the article. However, there are some build materials in which the carbon pickup cannot be tolerated or accommodated. Note that accommodation is not always possible solution, e.g. for already existing build material lots, or an economical alternative, e.g. when it is necessary to special order the build material to a lower than usual carbon level.

It may occur to the person skilled in the art to reduce the amount of binder to achieve a concomitant reduction in the binder's residual carbon and thus in the carbon pickup. However, in practice this is a solution having very little scope. When too little binder is present in the as-printed article or the cured article, the article does not have sufficient strength to maintain its structural integrity. The loss of structural integrity is often first manifested by the loss of sharp corners, the breaking off of small features, and the rubbing away of fine surface features during gentle handling of the article. At grosser levels of structural integrity loss, the article breaks apart into large pieces or totally disintegrates.

Another solution that may occur to a person skilled in the art is to try another class of polymers to supply the component of the binder that results in the requisite amount of structural integrity of the as-printed or as-cured article. This component is referred to herein as the “binding agent” of the binder. However, problems quickly arise here because of the extreme sensitivity had upon the ability of a binder to be printed from a printing mechanism by the fluid properties of the binder. Chief among these fluid properties are the binder's viscosity, surface tension, and rate of evaporation. These properties are also very important in the ability of the binder, after being jetted from a printing mechanism, to perform its proper role in the powder bed. This means that the binder has to be able to penetrate through the uppermost layer of the build bed, without a significant amount of ballistic damage to this uppermost layer, while wetting and interconnecting the powder particles only in the desired portion of this layer and reach (and wet and interconnect to the top layer) the printed-upon surface of the underlying layer without pooling upon that surface or continuing into the powder bed below the top layer where there is no printed-upon surface in the underlying layer.

### SUMMARY OF THE INVENTION

The present invention overcomes the problem with carbon increase described above by providing a binder for binder jetting three-dimensional printing that results in a much lower carbon increase after post-processing. The present invention also includes making articles by binder jetting three-dimensional printing using such inventive binders.

### DESCRIPTION OF PREFERRED EMBODIMENTS

Some preferred embodiments of the present invention are described in this section in detail sufficient for one skilled in the art to practice the present invention without undue experimentation. It is to be understood, however, that the fact that a limited number of preferred embodiments are described in this section does not in any way limit the scope of the present invention as set forth in the claims.

It is to be understood that whenever a range of values is described herein, i.e. whether in this section or any other part of this patent document, the range includes its end points and every point therebetween as if each and every such point had been expressly described. Unless otherwise stated, the words “about” and “substantially” as used herein are to be construed as meaning the normal measuring and/or fabrication limitations related to the value or condition which the word “about” or “substantially” modifies. Unless expressly stated otherwise, the term “embodiment” is used herein to mean an embodiment of the present invention.

The inventor of the present invention discovered an inventive binder that is suitable for binder jetting three-dimensional printing that significantly reduces the carbon pickup in comparison to prior art binders. Such binders comprise water as a carrier, polyvinyl alcohol having special characteristics as a binding agent, and a glycol ether as a surfactant and/or humectant. Preferably, the glycol ether is 2-butoxyethanol. The relative amounts of these components are described herein in terms of weight percent.

The amount of polyvinyl alcohol is in the range of from about 3 to about 7 weight percent, and more preferably in the range of from about 4 to about 5 weight percent. When the amount of polyvinyl alcohol is below the wider range, the as-printed article and/or the cured article have too little structural integrity. When the amount of polyvinyl alcohol is above the wider range, the viscosity of the binder becomes too high to be jetted from a printing device. Also, since the amount of carbon pickup increases as the amount of polyvinyl alcohol increases in the binder, polyvinyl alcohol levels above the wider range can lead to an undesirable amount of carbon pickup.

The amount of gylcol ether is in the range of from about 4 to about 12 weight percent, and more preferably in the range of from about 5 to about 7 weight percent. When the amount of glycol ether is below the wider range, the surface tension of the binder is too high to either jet properly or properly wet the powder bed. Also, the binder may dry too quickly to keep the jetting orifices of the printing device from becoming inoperative due the formation between uses of a film of dried binder. When the amount of glycol ether is above the wider range, the surface tension of the binder is too low to keep the jetting orifices of the printing device from dripping between uses and to keep the binder from penetrating too far into the build bed.

Polyvinyl alcohol has the requisite special characteristics for use in the inventive binder when it has (a) a weight average molecular weight (“N”) that is greater than or equal to about 10,000 and less than or equal to about 70,000, (b) a degree of polymerization that is in the range of from about 150 to about 800, and (c) has a degree of hydrolyzation in the range of from about 75 percent to about 95 percent. Preferably, the polyvinyl alcohol has (a) an N that is greater than about 13,000 and less than about 20,000, (b) a degree of polymerization that is in the range of from about 150 to about 250, and (c) has a degree of hydrolyzation in the range of from about 85 percent to about 88 percent. The inventor has made the surprising discovery that only polyvinyl alcohol having these special characteristics enables a binder to produce as-printed and/or cured articles having the requisite amount of structural integrity described above while having a viscosity which falls within the wider range described in the next paragraph.

The viscosity measured at 20° C. of the inventive binders is in the range of from about 4 to about 15 centipoise, and more preferably in the range of from about 5 to about 6.5 centipoise. The dynamic surface tension measured at 20° C. of the inventive binders is in the range of from about 26 to about 40 dyne/centimeter, and more preferably in the range of from about 35 to about 37 dyne/centimeter. When the viscosity and/or surface tension of the binder is outside of these ranges, the binders do not perform well or even at all in the printing device and/or in the powder bed.

The binders of the present invention can be produced by stirring into the water the glycol ether and an aqueous solution of the polyvinyl alcohol at room temperature until the binder is a uniform solution of its components.

Embodiments include methods of binder jetting three-dimensional printing using the inventive binder as the jetted fluid.

While only a few embodiments of the present invention have been shown and described, it will be obvious to those skilled in the art that many changes and modifications may be made thereunto without departing from the spirit and scope of the invention as described in the claims. All United States patents and patent applications, all foreign patents and patent applications, and all other documents identified herein are incorporated herein by reference as if set forth in full herein to the full extent permitted under the law.

What is claimed is:

1. A binder for binder jetting three-dimensional printing comprising:
a) polyvinyl alcohol in the amount of from about 3 to about 7 weight percent, the polyvinyl alcohol having a weight average molecular weight in the range of about 10,000 to about 70,000, a degree of polymerization in the range of about 150 to about 800, and a degree of hydrolyzation in the range of from about 75 percent to 95 percent;
b) glycol ether in the amount of from about 5 to about 7 weight percent; and
c) water as a carrier;
wherein the binder has a viscosity at 20° C. in the range of from about 4 to about 15 centipoise and a dynamic surface tension at 20° C. in the range of from about 26 to about 40 dyne/centimeter.

2. A method of making an as-printed article comprising the step of binder jetting three-dimensional printing the as-printed article wherein the binder that is applied upon successive layers of a build material during the binder jetting three-dimensional printing comprises
a) polyvinyl alcohol in the amount of from about 3 to about 7 weight percent, the polyvinyl alcohol having a weight average molecular weight in the range of about 10,000 to about 70,000, a degree of polymerization in the range of about 150 to about 800, and a degree of hydrolyzation in the range of from about 75 percent to 95 percent;
b) glycol ether in the amount of from about 5 to about 7 weight percent; and
c) water as a carrier;
wherein the binder has a viscosity at 20° C. in the range of from about 4 to about 15 centipoise and a dynamic surface tension at 20° C. in the range of from about 26 to about 40 dyne/centimeter.
